(19) United States
(12) Patent Application Publication
(10) Pub. No.: US 2005/0048994 A1
(43) Pub. Date: Mar. 3, 2005

(54) Methods for convenient call transfer between first and second communication units of a party

(76) Inventors: David S. Benco, Winfield, IL (US); Kevin J. Overend, Elmhurst, IL (US); Baoling S. Sheen, Naperville, IL (US); Sandra Lynn True, St. Charles, IL (US); Kenneth J. Voight, Sugar Grove, IL (US)

Correspondence Address: Lucent Technologies Inc.;Docket Administaror, (Room 3J-219), 101 Crawfords Corner Road, Holmdel, NJ, 07733-3030, US

(21) Appl. No.: 10/649,258

(22) Filed: Aug. 27, 2003

(51) Int. Cl. H04Q 7/20

(52) U.S. Cl. 455/517

(57) ABSTRACT

Methods are disclosed for conveniently transferring calls between first and second communication units (e.g., a home or office phone and mobile phone, or vice versa) of a party, without requiring a designated “transfer” key and without requiring entry of a directory number of the second phone.

### FIELD OF THE INVENTION

This invention relates generally to the field of communication systems and, more particularly, to methods for convenient transfer of calls between first and second communication units (e.g., between wireline and wireless communication units) of a party.

### BACKGROUND OF THE INVENTION

Communication systems are well known in which persons may initiate or receive calls using communication units, for example, wireless communication units (e.g., mobile phones) or wireline communication unit (e.g., landline phones). Most typically, the call is a voice communication, but other forms of communication (e.g., data, video, fax, etc.) are also known. Often, persons have multiple communication units eligible for use depending on circumstances and timing of the call. For example, it is common for persons to carry a mobile phone in their vehicle or on their person and to have a landline phone (or fixed wireless phone) dedicated to their home or office. Generally, each phone is addressable by a separate directory number.

On occasion, a party may become engaged in a call on a first phone/number even though a second phone/number associated with the party is preferred or better adapted for the call, either at the outset or due to changed circumstances during the call. For example, a party may be engaged in a call on a home or office phone yet prefer to continue the communication on their mobile phone because they are about to leave their home or office; or conversely, a party may be engaged in a call on their mobile phone and wish to continue the communication on their home or office phone as they arrive at the home or office. Hence, it would be desirable to provide support for manual call transfers (i.e., without operator intervention) to or from mobile phones as the case may be.

To the extent manual call transfers are known, they rely upon the party pressing a designated “transfer” key and then entering a directory number associated with the second phone. Such transfer keys are provided on certain office phones but are generally not present on home phones or mobile phones. Moreover, even in cases where a transfer key exists, it is often inconvenient for the transferring party to enter a directory number of the second phone. Entering the directory number creates an unnecessary burden for transfers from a mobile to a home or office phone, or from a home or office phone to a mobile phone of the same party.

### SUMMARY OF THE INVENTION

These problems are solved and a technical advance is achieved in the art by a feature whereby a party may transfer an active call between first and second communication units in a manner that does not require the transferring party to enter the directory number of the second communication unit. Advantageously, the feature enables a party to conveniently and quickly transfer calls from a landline phone (e.g., home or office phone) to a mobile phone, or from a mobile phone to a landline phone of the same party.

In one embodiment, a method of the invention comprises receiving, from a party engaged in an active call, a request for transfer of the call from a first communication unit to a pre-provisioned second communication unit associated with the party. Responsive to the request, a subscriber database is consulted to determine the second communication unit and/or a directory number associated with the second communication unit. While maintaining a telephonic connection to the first communication unit, an attempt is made to establish a telephonic connection to the second communication unit. If the connection to the second communication unit is established, the connection to the first communication unit is dropped, thereby transferring the call from the first communication unit to the second communication unit of the party.

In another embodiment, a method of the invention comprises maintaining a database including indicia of at least a first communication unit and indicia of a second communication unit to which call transfers may be directed from the first communication unit. Upon receiving a call transfer request from the first communication unit, the database is consulted to determine the second communication unit and the call is transferred to the second communication unit.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented;

FIG. 2 is a flowchart of a method for transferring a call from a mobile phone to a landline phone of the same party; and

FIG. 3 is a flowchart of a method for transferring a call from a landline phone to a mobile phone of the same party.

### DESCRIPTION OF THE PREFERRED EMBODIMENT(S)

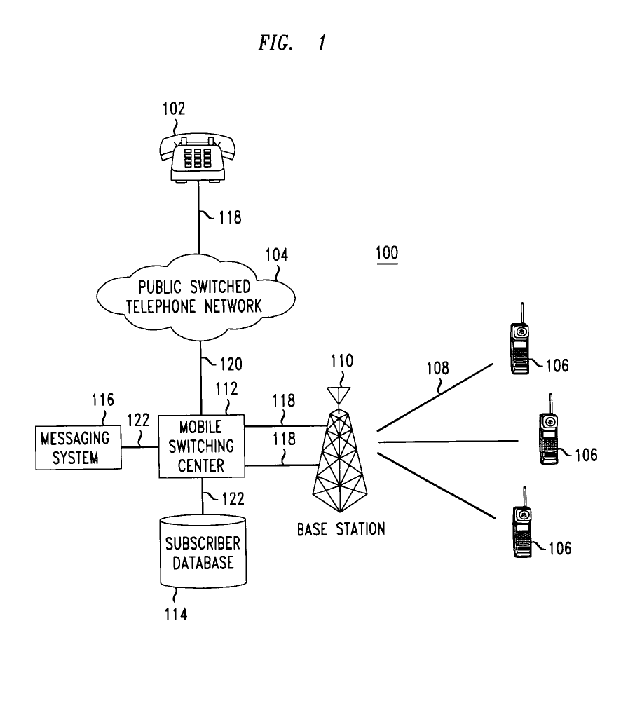

FIG. 1 depicts a communications system 100 including a wireline unit 102 (e.g., landline phone) and various wireless units 106 (e.g., mobile phones). Generally, any of the wireline or wireless units 102, 106 may be sources or recipients of calls. The wireline unit 102 is connected to the public switched telephone network (PSTN) 104 via link 118. Link 118 may comprise, without limitation, a conventional subscriber line, ISDN line, Ethernet LAN, and the like. The wireless units 106 communicate via RF resources 108 with one or more base stations 110. The base stations 110 are connected via links 118 to a call processing control entity, commonly known as Mobile Switching Center (MSC) 112.

The MSC 112 may comprise, for example, a 5ESS® switching system, available from Lucent Technologies, Inc. As shown, the communication system 100 of FIG. 1 includes a single MSC 112. However, as will be appreciated, the MSC 112 is a functional entity that may reside in multiple physical switches or combined into a single switch. The MSC 112 may be configured for operation with generally any suitable circuit, cell, or packet switching technology. The MSC 112 includes a memory and processor (not shown), for storing and executing software routines for processing and switching calls, for providing various call features to calling parties and for providing access to the PSTN 104. The MSC 112 is connected to the PSTN 104 via link 120. Link 120 is a logical link that may be physically realized, without limitation, by conventional subscriber lines, ISDN lines, WAN links, wireless links, and the like. Link 120 carries signaling information and/or payload information between MSC 112 and PSTN 104. In one embodiment, the payload information comprises voice information. Alternatively or additionally, the payload information may comprise information associated with video, data, text or generally any communication media.

As shown, data links 122 connect the MSC 112 to a subscriber database 114 and a messaging system 116. The data links 122 may comprise LAN or WAN links or virtually any type of link suitable for transporting voice or signaling information to and from the MSC 112. The database 114 stores information including subscriber data, service information and the like. In one embodiment, the subscriber information includes indicia of different phones/directory numbers associated with various subscribers (e.g., indicia of home, office, mobile phones) and the service information includes information associated with a call transfer feature. In one embodiment, the information associated with the call transfer feature includes: a “flag” or other suitable indicator of whether a particular subscriber is eligible to use the call transfer feature (i.e., call transfer feature is enabled); indicia of which number(s) from which a particular subscriber may invoke the transfer feature (i.e., request a transfer) and indicia of certain number(s) (“transfer numbers”) to which the transfer may be directed. In one embodiment, this information is provisioned some time in advance of actual transfer request(s). For example, the information may be provisioned by a service provider in conjunction with the subscriber upon activation of service and/or upon activation of the call transfer feature. As will be appreciated, the information might also be modified from time to time to add, remove or change transfer numbers, change directory numbers and the like.

In one exemplary embodiment, the database includes information indicating for one or more subscribers a home phone (with home directory number) and mobile phone (with mobile phone directory number); indicating that transfers may be invoked from the mobile phone to the home phone and from the home phone to the mobile phone. In embodiments of the present invention, this information is used by the MSC 112 to transfer calls, upon request, from a subscriber's mobile phone to their home phone or from their home phone to their mobile phone. As will be appreciated, the database may be tailored to reflect additional phones (e.g., office phone, second home phone, etc.), enablement/disablement of the transfer feature to/from certain phones, and so forth according to provisioning data in the database.

The messaging system 116 is used to play messages, where appropriate, associated with the transfer (or attempted transfer). As will be appreciated, both the database 114 and messaging system 116 are logical entities that may be realized by unitary, centralized devices or multiple, distributed devices. The database 114 and messaging system 116 may be linked to the PSTN 104 rather than (or in addition to) the MSC 112.

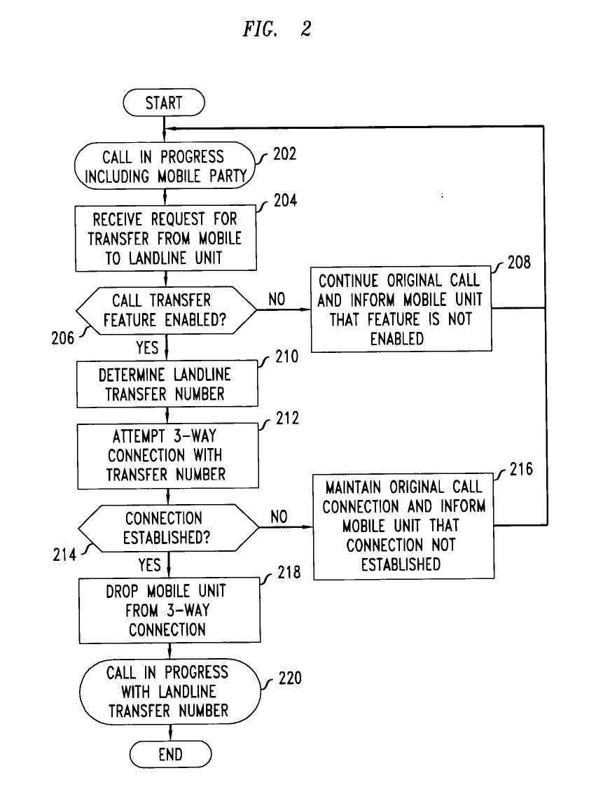

Turning now to FIG. 2, there is shown a flowchart of a method that may be implemented in the communication system of the type shown in FIG. 1, for a party to transfer a call from a mobile phone 106 to a landline phone 102 (e.g., home or office phone) of the party. The steps of FIG. 2 are implemented, where applicable, using stored software routines within the mobile phone 106 and/or switching system. The term “switching system” shall be understood to comprise any combination of the MSC 112 and PSTN-based switching system (not shown), for example, a 5ESS® switching system residing within the PSTN 104.

The method presumes at block 202, that the party is engaged in a call using a mobile phone 106, the party thereby defining a mobile party. The method further presumes that the mobile party has defined one or more landline numbers that an in-progress call on the mobile phone can be transferred to and those numbers are stored in the subscriber database 114. The mobile party may comprise a calling party or called party. The mobile party may be in communication with other mobile parties, landline parties, or generally any party/device that is able to communicate with the mobile phone 106. Generally, the call has one or more defined attributes such as, for example, billing rate, assigned resources, and the like.

Some time during the call, the mobile party requests transfer of the call. In one embodiment, the mobile party invokes the transfer request by entering a code (e.g., *88) on the mobile phone. Alternatively, the mobile party might invoke the transfer request by pressing a button, using a point-and-click method or using generally any other appropriate user interface available to the mobile party. The switching system receives the request for transfer at step 204 and interprets the request as a request for transfer to a pre-provisioned landline phone/DN indicated in the subscriber database 114. Accordingly, the mobile party need not enter the DN of the phone to which transfer is requested at time of the request.

At step 206, the switching system determines whether the call transfer feature is enabled or disabled from the requesting phone. Enablement status of the call transfer feature may depend, for example, on timely payment of a subscription fee, sufficient prepaid balance, subscriber preferences or the like. If the call transfer feature is not enabled, the switching system at step 208 continues the original call and causes the messaging system 116 to inform the requesting mobile unit that the feature is not enabled. If the call transfer feature is enabled, the switching system at step 210 consults the subscriber database to determine the transfer number. In one embodiment, the database indicates a single number that calls from the mobile can be transferred to. For example, the subscriber may indicate the subscriber's home number as the transfer number; and the transfer number is pre-provisioned in the subscriber database 112. Thus, if so indicated in the database, transfers from the mobile may be directed to the subscriber's home phone. As another example, the subscriber may indicate the subscriber's office number as the transfer number and, if so indicated in the database, transfers from the mobile would be directed to the subscriber's office phone.

Optionally, the database may indicate a plurality of numbers as being eligible for call transfers from the mobile. For example, the subscriber may indicate both the subscriber's home number and work number as eligible transfer numbers. In one embodiment, alternative codes may be used to invoke transfers to the different numbers. For example, the subscriber at step 204 might enter *88 to transfer to the subscriber's home phone or *89 to transfer to the subscriber's office phone. In such case, the switching system will determine the transfer number at step 210 by recognizing an association between the code entered and the desired transfer number. Alternatively, if the database includes multiple transfer numbers but does not provide for alternative codes, the subscriber may enter supplemental numbers to identify which number to transfer to. The supplemental number may be entered, for example, coincident to step 204 (e.g., *88, ‘1’ to request transfer to the subscriber's home phone or *88, ‘2’ to request transfer to the subscriber's office phone) or coincident to step 210 following prompting by the switching system and messaging system: “enter ‘1’ to transfer to your home phone; enter ‘2’ to transfer to your office phone.” The switching system will interpret the digit ‘1’ or ‘2’ as a request for transfer to the home or office phone, respectively. As will be appreciated, any of several alternative codes/supplemental numbers may be used to enable the subscriber to select from multiple eligible transfer numbers. Preferably, the code/number sequence will not comprise the directory number of the selected phone, but rather will comprise a short sequence that may be executed conveniently and rapidly from the mobile phone.

Having determined a transfer number at step 210, the switching system at step 212 attempts a 3-way connection with the transfer number. Methods for attempting 3-way call connections are well known in the art and will not be described herein. Suffice it to say that the switching system attempts to add to the connections of the original call, a connection to the transfer number. The switching system attempts connection by assigning communication resources as may be appropriate, ringing the transfer number and detecting answer (or no answer) of the transfer phone. In one embodiment, a successful connection is established when the transfer phone is answered.

If a connection is not established to the transfer number, determined at step 214, the switching system at step 216 maintains the original call connection and causes the messaging system 116 to inform the mobile unit that the connection is not established. If a connection is established, the switching system at step 218 drops the mobile unit from the 3-way connection, thereby continuing the original call but replacing the mobile unit with the appropriate transfer unit indicated in the subscriber database. At step 220, the call is in progress with the transfer unit. In one embodiment, at step 220, the switching system redefines one or more attributes (e.g., billing rates, resources, etc.) associated with the call.

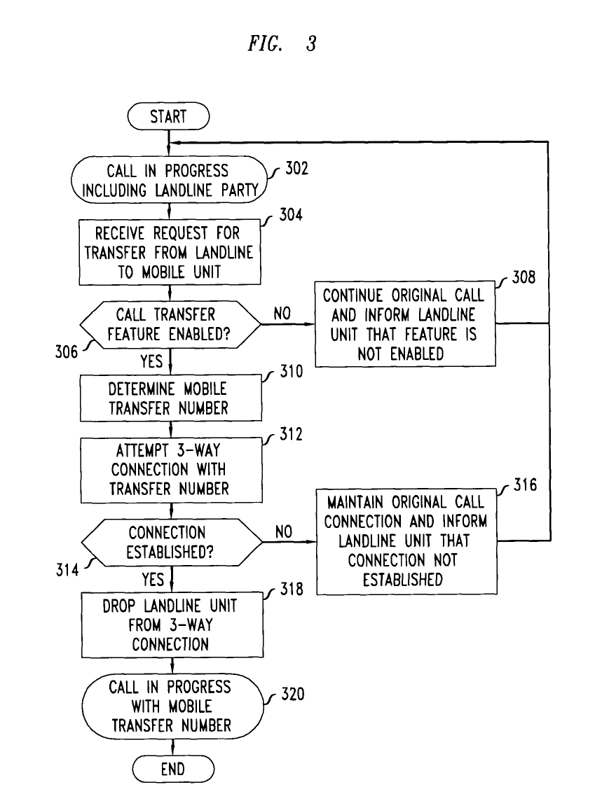

Turning now to FIG. 3, there is shown a flowchart of a method that may be implemented in the communication system of the type shown in FIG. 1, for a party to transfer a call from a landline phone 102 (e.g., home or office phone) to a mobile phone 106. The steps of FIG. 3 are implemented, where applicable, using stored software routines within the landline phone 102 and/or switching system. The term “switching system” shall be understood to comprise any combination of a PSTN-based switching system (not shown) and the MSC 112.

The method presumes at block 302, that the party is engaged in a call using a landline phone 102, the party thereby defining a landline party. The method further presumes that the landline party has defined one or more mobile numbers that an in-progress call on the landline phone can be transferred to and those numbers are stored in the subscriber database 114. The landline party may comprise a calling party or called party. The landline party may be in communication with other landline parties, mobile parties, or generally any party/device that is able to communicate with the landline phone 102. Generally, the call has one or more defined attributes such as, for example, billing rate, assigned resources, and the like.

Some time during the call, the landline party requests transfer of the call. In the preferred embodiment, the landline party invokes the transfer request by entering a code (e.g., *88) on the landline phone. Alternatively, the landline party might invoke the transfer request by pressing a button, using a point-and-click method or using generally any other appropriate user interface available to the landline party. The switching system receives the request for transfer at step 304 and interprets the request as a request for transfer to a pre-provisioned mobile phone/DN indicated in the subscriber database 114. Accordingly, the landline party need not enter the DN of the phone to which transfer is requested at time of the request.

At step 306, the switching system determines whether the call transfer feature is enabled or disabled. Enablement status of the call transfer feature may depend, for example, on timely payment of a subscription fee, sufficient prepaid balance, subscriber preferences or the like. If the call transfer feature is not enabled, the switching system at step 308 continues the original call and causes the messaging system 116 to inform the requesting landline unit that the feature is not enabled. If the call transfer feature is enabled, the switching system at step 310 consults the subscriber database to determine the transfer number. In one embodiment, the subscriber indicates a single mobile number that calls from the landline can be transferred to. For example, the subscriber may indicate the subscriber's mobile phone number as the transfer number; and the transfer number is pre-provisioned in the subscriber database 112. Thus, if so indicated in the database, transfers from the subscriber's home or office phone may be directed to the subscriber's mobile phone.

Optionally, the landline subscriber may define a plurality of eligible transfer numbers and those numbers are stored in the subscriber database. For example, the subscriber may indicate a second mobile number or landline number as eligible transfer numbers. In one embodiment, alternative codes may be used to invoke transfers to the different numbers. For example, the subscriber at step 304 might enter *88 to transfer to the subscriber's mobile phone or *89 to transfer to a second landline phone. In such case, the switching system will determine the transfer number at step 310 by recognizing an association between the code entered and the desired transfer number. Alternatively, if the database includes multiple transfer numbers but does not provide for alternative codes, the subscriber may enter supplemental numbers to identify which number to transfer to. The supplemental number may be entered, for example, coincident to step 304 (e.g., *88, ‘1’ to request transfer to the subscriber's mobile phone or *88, ‘2’ to request transfer to a second landline phone) or coincident to step 310 following prompting by the switching system and messaging system: “enter ‘1’ to transfer to your mobile phone; enter ‘2’ to transfer to your second landline phone.” In either case, the switching system will interpret the digit ‘1’ or ‘2’ as a request for transfer to the mobile or second landline phone, respectively.

Having determined a transfer number at step 310, the switching system at step 312 attempts a 3-way connection with the transfer number. Methods for attempting 3-way call connections are well known in the art and will not be described herein. Suffice it to say that the switching system attempts to add to the connections of the original call, a connection to the transfer number. The switching system attempts connection by assigning communication resources as may be appropriate, ringing the transfer number and detecting answer (or no answer) of the transfer phone. In one embodiment, a successful connection is established when the transfer phone is answered.

If a connection is not established to the transfer number, determined at step 314, the switching system at step 316 maintains the original call connection and causes the messaging system 116 to inform the landline unit that the connection is not established. If a connection is established, the switching system at step 318 drops the landline unit from the 3-way connection, thereby continuing the original call but replacing the landline unit with the appropriate transfer unit indicated in the subscriber database. At step 320, the call is in progress with the transfer unit. In one embodiment, at step 320, the switching system redefines one or more attributes (e.g., billing rates, resources, etc.) associated with the call.

In one embodiment, the same code, button etc. used to request transfers from a landline to a mobile phone may be used to request transfers from a mobile to a landline phone. Thus, for example, the code *88 may be used for both landline-to-mobile and mobile-to-landline transfers. The switching system recognizes the phone from which the requested was initiated and consults the database 114 to determine if transfers are enabled from the requesting phone and to determine eligible transfer number(s) associated with the requesting phone.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising the steps of:
receiving, from a party engaged in an active call, a request for transfer of the call from a first communication unit to a pre-provisioned second communication unit associated with the party;
consulting a database to determine the second communication unit;
while maintaining a telephonic connection to the first communication unit, attempting to establish a telephonic connection to the second communication unit;
if the connection to the second communication unit is established, dropping the connection to the first communication unit, thereby transferring the call from the first communication unit to the second communication unit of the party.

2. The method of claim 1, wherein the step of receiving a request for transfer is accomplished without receiving a directory number of the second communication unit.

3. The method of claim 1, wherein the first communication unit comprises a mobile phone and the second communication unit comprises a landline phone associated with the party.

4. The method of claim 1, wherein the first communication unit comprises a landline phone and the second communication unit comprises a mobile phone of the party.

5. The method of claim 1, further comprising, if the connection to the second communication unit is not established:
sending a message to the first communication unit indicating that the requested transfer did not occur.

6. The method of claim 1, wherein the step of consulting a database comprises consulting the database to determining a directory number of the second communication unit.

7. The method of claim 1, comprising:
determining a directory number of the first communication unit;
consulting a database to determine an enablement status of the first communication unit to invoke a call transfer to the second communication unit;
if the first communication unit is not enabled to invoke the call transfer, sending a message to the first communication unit indicating that the requested transfer is not enabled.

8. A method comprising:
maintaining a database including indicia of at least a first communication unit and indicia of a second communication unit to which call transfers may be directed from the first communication unit;
receiving, from the first communication unit, a call transfer request;
consulting the database to determine the second communication unit; and
transferring the call from the first communication unit to the second communication unit.

9. The method of claim 8, wherein the first communication unit comprises a mobile phone and the second communication unit comprises a landline phone associated with a party.

10. The method of claim 8, wherein the first communication unit comprises a landline phone and the second communication unit comprises a mobile phone of the party.

11. The method of claim 8, wherein the step of receiving a call transfer request is accomplished without receiving a directory number of the second communication unit.

12. The method of claim 8, wherein the step of transferring the call comprises:
while maintaining a telephonic connection to the first communication unit, establishing a telephonic connection to the second communication unit;
after the connection to the second communication unit is established, dropping the connection to the first communication unit.
